(19) United States
(12) Patent Application Publication
(10) Pub. No.: US 2023/0005066 A1
(43) Pub. Date: Jan. 5, 2023

(54) SYSTEMS AND METHODS FOR GENERATING EXPECTATIONS FOR VALIDATING A POLICY SYSTEM

(71) Applicant: BlueOwl, LLC, San Francisco, CA (US)

(72) Inventor: Shilpi Bansal, Pleasant Hill, CA (US)

(21) Appl. No.: 16/922,950

(22) Filed: Jul. 7, 2020

(51) Int. Cl. G06Q 40/08; G06K 9/62; G06N 3/02; G06N 20/00

(52) U.S. Cl. CPC G06Q 40/08; G06K 9/6256; G06K 9/6262; G06N 3/02; G06N 20/00

(57) ABSTRACT

Methods and systems for generating one or more expectations for a policy scenario. For example, a computer-implemented method includes: receiving, by an expectation generating model, a policy scenario associated with a policy lifecycle, the policy scenario including one or more events; sequentially generating, by the expectation generating model for each event of the one or more events, one or more expectations of one or more policy details associated with the policy lifecycle by at least: generating a first set of expectations for a first event of the one or more events; and generating a second set of expectations for a second event of the one or more events based at least in part upon the first set of expectations.

### FIELD OF THE DISCLOSURE

Some embodiments of the present disclosure are directed to testing of policy system. More particularly, certain embodiments of the present disclosure provide methods and systems for generating expectations for validating a policy system. Merely by way of example, the present disclosure has been applied to insurance policies, but it would be recognized that the present disclosure has much broader range of applicability.

### BACKGROUND OF THE DISCLOSURE

In the insurance domain, validating a large quantity policy of lifecycle scenarios is a challenging problem known to be expensive, not just in time but also cost, in part due to its significant resource consumption. One challenge is the determination of expectations of validation results for various complex lifecycle scenarios, which often include large quantities of events each requiring validation. Therefore, systems and methods for improving efficiency in validating large quantities of policy lifecycle scenarios are desirable.

### BRIEF SUMMARY OF THE DISCLOSURE

Some embodiments of the present disclosure are directed to testing of policy system. More particularly, certain embodiments of the present disclosure provide methods and systems for generating expectations for validating a policy system. Merely by way of example, the present disclosure has been applied to insurance policies, but it would be recognized that the present disclosure has much broader range of applicability.

In various embodiments, a computer-implemented method for generating one or more expectations for a policy scenario includes: receiving, by an expectation generating model, a policy scenario associated with a policy lifecycle, the policy scenario including one or more events; sequentially generating, by the expectation generating model for each event of the one or more events, one or more expectations of one or more policy details associated with the policy lifecycle by at least: generating a first set of expectations for a first event of the one or more events; and generating a second set of expectations for a second event of the one or more events based at least in part upon the first set of expectations.

In various embodiments, a system for generating one or more expectations for a policy scenario includes: a policy scenario receiving module configured to: receive, by an expectation generating model, a policy scenario associated with a policy lifecycle, the policy scenario including one or more events; and an expectation generating module configured to sequentially generate, by the expectation generating model for each event of the one or more events, one or more expectations of one or more policy details associated with the policy lifecycle by at least: generating a first set of expectations for a first event of the one or more events; and generating a second set of expectations for a second event of the one or more events based at least in part upon the first set of expectations.

In various embodiments, a non-transitory computer-readable medium with instructions stored thereon, that when executed by a processor, causes the processor to perform: receiving, by an expectation generating model, a policy scenario associated with a policy lifecycle, the policy scenario including one or more events; sequentially generating, by the expectation generating model for each event of the one or more events, one or more expectations of one or more policy details associated with the policy lifecycle by at least: generating a first set of expectations for a first event of the one or more events; and generating a second set of expectations for a second event of the one or more events based at least in part upon the first set of expectations.

Depending upon the embodiment, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

FIG. 1 is a simplified diagram showing a system for generating expectations, according to various embodiments of the present disclosure.

FIG. 2 is a simplified diagram showing a method for generating expectations, according to various embodiments of the present disclosure.

FIG. 3 is a simplified diagram showing a computer device, according to various embodiments of the present disclosure.

### DETAILED DESCRIPTION OF THE DISCLOSURE

Some embodiments of the present disclosure are directed to testing of policy system. More particularly, certain embodiments of the present disclosure provide methods and systems for generating expectations for validating a policy system. Merely by way of example, the present disclosure has been applied to insurance policies, but it would be recognized that the present disclosure has much broader range of applicability.

One or More Systems for Generating Expectations According to Various Embodiments

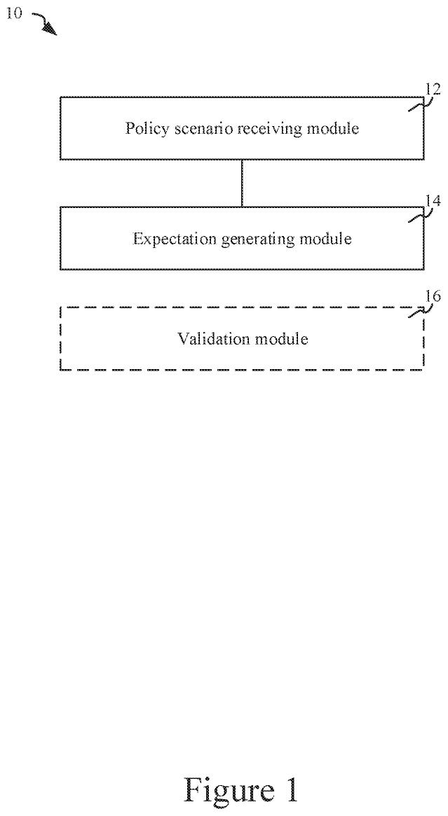

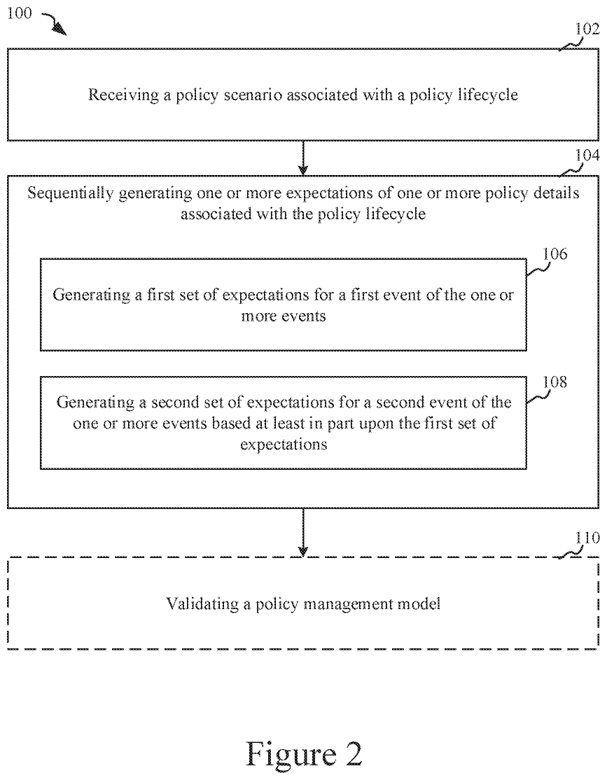

FIG. 1 is a simplified diagram showing a system for generating expectations according to various embodiments of the present disclosure. This diagram is merely an example, which should not unduly limit the scope of the claims. One of ordinary skill in the art would recognize many variations, alternatives, and modifications. In some examples, the system 10 includes a policy scenario receiving module 12 and an expectation generating module 14. In certain examples, the system 10 is configured to implement method 100 of FIG. 2. Although the above has been shown using a selected group of components, there can be many alternatives, modifications, and variations. For example, some of the components may be expanded and/or combined. Some components may be removed. Other components may be inserted to those noted above. Depending upon the embodiment, the arrangement of components may be interchanged with others replaced.

In various embodiments, the policy scenario receiving module 12 is configured to receive a policy scenario associated with a policy lifecycle. In some examples, the policy scenario receiving module 12 is configured to receive, by the expectation generating model, the policy scenario associated with the policy lifecycle. In various examples, the policy scenario includes one or more events. In some examples, the policy scenario receiving module 12 is configured to receive, such as by the expectation generating model, one or more initial values of the one or more policy details. In some examples, the one or more policy details includes billing information, operator information, payment details, payment history, policy update history, rating factor, vehicle information, and/or coverage information. In some examples, the one or more events includes policy purchase, driver modification, driver addition, driver removal, invoicing, vehicle modification, vehicle addition, vehicle removal, coverage modification, property modification, property addition, property removal, user info modification, risk addition, risk removal, risk update, profile update, payment method update, manual payment, policy reinstatement, policy repurchase, policy rewrite, policy re-rating, and/or policy termination. In some examples, the expectation generating model is a neural network.

In various embodiments, the expectation generating module 14 is configured to sequentially generate one or more expectations of one or more policy details associated with the policy lifecycle. In some examples, the expectation generating module 14 is configured to sequentially generate, for each event of the one or more events, one or more expectations of one or more policy details associated with the policy lifecycle. In various examples, the expectation generating module 14 is configured to sequentially generate, by the expectation generating model for each event of the one or more events, one or more expectations of one or more policy details associated with the policy lifecycle. In certain examples, the expectation generating module 14 is configured to sequentially generate, by the expectation generating model for each event of the one or more events, one or more expectations of one or more policy details associated with the policy lifecycle by at least: generating a first set of expectations for a first event of the one or more events; and generating a second set of expectations for a second event of the one or more events based at least in part upon the first set of expectations. In certain examples, the generating the first set of expectations for the first event of the one or more events includes generating the first set of expectations based at least in part upon the one or more initial values.

In certain embodiments, the system 10 further includes a validation module 16 configured to validate a policy management model. In certain examples, the validation module 16 is configured to validate a policy management model by at least: receiving, by the policy management model, the policy scenario associated with the policy lifecycle; sequentially generating, by the policy management model for each event of the one or more events, one or more value updates of the one or more policy details; and determining the policy management model to be satisfactory or unsatisfactory. In certain examples, sequentially generating, by the policy management model for each event of the one or more events, one or more value updates of the one or more policy details includes: generating a first set of value updates for the first event of the one or more events; and generating a second set of value updates for the second event of the one or more events based at least in part upon the first set of value updates.

In various examples, the validation module 16 is configured to determine the policy management model to be unsatisfactory if, for any event of the one or more events, the one or more value updates deviates from the one or more expectations greater than or equal to one or more predetermined thresholds. In various examples, the validation module 16 is configured to determine the policy management model to be satisfactory if, for substantially all (e.g., more than 50%, 60%, 70%, 80%, 90%, 95%, or 99%) of the one or more events, the one or more value updates deviates from the one or more expectations lesser than the one or more predetermined thresholds. In certain examples, the validation module 16 is configured to determine the policy management model to be unsatisfactory if, for any event of the one or more events, the one or more value updates deviates from the one or more expectations greater than one or more predetermined thresholds. In various examples, the validation module 16 is configured to determine the policy management model to be satisfactory if, for substantially all (e.g., more than 50%, 60%, 70%, 80%, 90%, 95%, or 99%) of the one or more events, the one or more value updates deviates from the one or more expectations lesser than or equal to the one or more predetermined thresholds. In certain examples, the validation module 16 is configured to determine the policy management model to be unsatisfactory if, for more than a predetermined threshold amount of events of the one or more events, the one or more value updates deviates from the one or more expectations greater than one or more predetermined thresholds. In various examples, the validation module 16 is configured to validate the policy management model by further receiving, by the policy management model, the one or more initial values of the one or more policy details. In certain examples, the generating the first set of value updates for the first event of the one or more events includes generating the first set of value updates based at least in part upon the one or more initial values.

One or More Methods for Generating Expectations According to Various Embodiments

FIG. 2 is a simplified method for generating expectations according to various embodiments of the present disclosure. This diagram is merely an example, which should not unduly limit the scope of the claims. One of ordinary skill in the art would recognize many variations, alternatives, and modifications. The method 100 includes a process 102 of receiving a policy scenario associated with a policy lifecycle and a process 104 of sequentially generating one or more expectations of one or more policy details associated with the policy lifecycle. Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others replaced. For example, some or all processes of the method are performed by a computing device or a processor directed by instructions stored in memory. As an example, some or all processes of the method are performed according to instructions stored in a non-transitory computer-readable medium.

In various embodiments, the process 102 of receiving a policy scenario associated with a policy lifecycle includes receiving, by an expectation generating model, the policy scenario associated with the policy lifecycle. In certain examples, the policy scenario includes one or more events. In some examples, the one or more policy details includes billing information, operator information, payment details, payment history, policy update history, rating factor, vehicle information, and/or coverage information. In some examples, the one or more events includes policy purchase, driver modification, driver addition, driver removal, invoicing, vehicle modification, vehicle addition, vehicle removal, coverage modification, property modification, property addition, property removal, user info modification, risk addition, risk removal, risk update, profile update, payment method update, manual payment, policy reinstatement, policy repurchase, policy rewrite, policy re-rating, and/or policy termination. In some examples, the expectation generating model is a neural network.

In various embodiments, the process 104 of sequentially generating one or more expectations of one or more policy details associated with the policy lifecycle includes sequentially generating, such as by the expectation generating model, for each event of the one or more events, one or more expectations of one or more policy details associated with the policy lifecycle. In some examples, the process 104 of sequentially generating one or more expectations includes a process 106 of generating a first set of expectations for a first event of the one or more events and a process 108 of generating a second set of expectations for a second event of the one or more events based at least in part upon the first set of expectations.

In certain embodiments, the method 100 further includes a process 110 of validating a policy management model. In some examples, validating a policy management model includes: receiving, by the policy management model, the policy scenario associated with the policy lifecycle; sequentially generating, by the policy management model for each event of the one or more events, one or more value updates of the one or more policy details, and determining the policy management model to be satisfactory or unsatisfactory. In certain examples, sequentially generating, by the policy management model for each event of the one or more events, one or more value updates of the one or more policy details includes: generating a first set of value updates for the first event of the one or more events; and generating a second set of value updates for the second event of the one or more events based at least in part upon the first set of value updates.

In certain examples, determining the policy management model to be unsatisfactory includes determining the policy management model to be unsatisfactory if, for any event of the one or more events, the one or more value updates deviates from the one or more expectations greater than or equal to one or more predetermined thresholds. In certain examples, determining the policy management model to be satisfactory includes determining the policy management model to be satisfactory if, for substantially all (e.g., greater than 50%, 60%, 70%, 80%, 90%, 95%, or 99%) of the one or more events, the one or more value updates deviates from the one or more expectations lesser than the one or more predetermined thresholds. In certain examples, determining the policy management model to be unsatisfactory includes determining the policy management model to be unsatisfactory if, for any event of the one or more events, the one or more value updates deviates from the one or more expectations greater than one or more predetermined thresholds. In certain examples, determining the policy management model to be satisfactory includes determining the policy management model to be satisfactory if, for substantially all (e.g., greater than 50%, 60%, 70%, 80%, 90%, 95%, or 99%) of the one or more events, the one or more value updates deviates from the one or more expectations lesser than or equal to the one or more predetermined thresholds. In certain examples, determining the policy management model to be unsatisfactory includes determining the policy management model to be unsatisfactory if, for more than a predetermined threshold amount of events of the one or more events, the one or more value updates deviates from the one or more expectations greater than or equal to one or more predetermined thresholds.

In some embodiments, the method 100 further includes receiving, such as by the expectation generating model, one or more initial values of the one or more policy details. In certain examples, the process 106 of generating the first set of expectations for the first event of the one or more events includes generating the first set of expectations based at least in part upon the one or more initial values. In some examples, the method 100 further includes receiving, by the policy management model, one or more initial values of one or more policy details. In certain examples, the generating the first set of value updates for the first event of the one or more events includes generating the first set of value updates based at least in part upon the one or more initial values.

In certain embodiments, systems and/or methods of the present disclosure utilizes a custom keyword-driven framework configured to receive, from a user or tester, a predefined keywor for each event that is to be performed as part of a policy scenario, where one or more processes of method 100 is subsequently executed for each event, such as based on a final keyword. For example, a test may define a policy event to purchase auto policy as a keyword, define the policy event to perform a policy action to add vehicle to policy at a nearest date (or a least expensive date, such as when executing multiple tests parallely) within a specified range, defines an action to move a clock to a desired time on a desired date or a nearest time (or a least expensive date, such as when executing multiple tests parallely) within a specified range, and perform each policy event defined above and, for each event, generate expectations and validate all policy details, documents, billing, sub-ledge, and/or any policy changes performed. In some examples, systems and/or methods of the present disclosure utilizing such custom keyword-driven framework helps reduce test file size and improves readability of said test files.

One or More Systems for Training an Expectation Generating Model According to Certain Embodiments

In certain embodiments, a system for training an expectation generating model includes a policy scenario receiving module, an expectation generating module, a result receiving module, and an evaluation module. Although the above has been shown using a selected group of components, there can be many alternatives, modifications, and variations. For example, some of the components may be expanded and/or combined. Some components may be removed. Other components may be inserted to those noted above. Depending upon the embodiment, the arrangement of components may be interchanged with others replaced.

In certain embodiments, the policy scenario receiving module is configured to receive a policy scenario associated with a policy lifecycle. In certain examples, the policy scenario receiving module is configured to receive, by the expectation generating model, the policy scenario associated with a policy lifecycle. In some examples, the policy scenario includes one or more events. In some examples, the one or more events includes policy purchase, driver modification, driver addition, driver removal, invoicing, vehicle modification, vehicle addition, vehicle removal, coverage modification, property modification, property addition, property removal, user info modification, risk addition, risk removal, risk update, profile update, payment method update, manual payment, policy reinstatement, policy repurchase, policy rewrite, policy re-rating, and/or policy termination. In various examples, the policy scenario receiving module is configured to receive one or more initial values of one or more policy details associated with a user policy. In certain examples, the policy scenario receiving module is configured to receive, by an expectation generating model, the one or more initial values of one or more policy details associated with a user policy. In some examples, the one or more policy details includes billing information, operator information, payment details, payment history, policy update history, rating factor, vehicle information, and/or coverage information.

In certain embodiments, the expectation generating module is configured to generate one or more expectations of the one or more policy details. In some examples, the expectation generating module is configured to generate, by the expectation generating model for each event of the one or more events, one or more expectations of the one or more policy details. In various examples, the expectation generating module is configured to sequentially generate the one or more expectations. In some examples, the expectation generating module is configured to generate a first set of expectations for a first event of the one or more events and generate a second set of expectations for a second event of the one or more events based at least in part upon the first set of expectations. In certain examples, the expectation generating module is configured to generate a first set of expectations for a first event based at least in part upon the one or more initial values.

In various embodiments, the result receiving module is configured to receive, by a validation model for each event of the one or more events, one or more results of the one or more policy details. In some examples, the result receiving module is configured to receive, by a validation model for each event of the one or more events, one or more results of the one or more policy details.

In various embodiments, the evaluation module is configured to determine the expectation generating model to be unsatisfactory. In some examples, the evaluation module is configured to determine the expectation generating model to be unsatisfactory if, for any event of the one or more events, the one or more expectations deviates from the one or more results greater than or equal to one or more predetermined thresholds. In various examples, the evaluation module is configured to determine the expectation generating model to be satisfactory. In some examples, the evaluation module is configured to determine the expectation generating model to be satisfactory if, for substantially all (e.g., more than 50%, 60%, 70%, 80%, 90%, 95%, or 99%) of the one or more events, the one or more expectations deviates from the one or more results lesser than the one or more predetermined threshold.

In some embodiments, the system further includes a results generating module configured to generate the one or more results of the one or more policy details, such as based at least in part upon the one or more initial values of the one or more policy details. In some examples, the results generating module is configured to generate, by the validation model for each event of the one or more events, the one or more results of the one or more policy details, such as based at least in part upon the one or more initial values of the one or more policy details. In certain examples, the expectation generating module is configured to sequentially generate the one or more results. In some examples, the expectation generating module is configured to generate a first set of results for a first event of the one or more and generate a second set of results for a second event of the one or more events based at least in part upon the first set of results. In certain examples, the expectation generating module is configured to generate the first set of results based at least in part upon the one or more initial values.

In some embodiments, the system further includes a model changing module configured to change one or more parameters of the expectation generating model based at least in part upon one or more losses associated with the deviation of the one or more expectations from the one or more results. In certain examples, the expectation generating model is a machine learning model, such as an artificial neural network including adjustable weights and biases as parameters that are configured to be changed based at least in part upon one or more losses associated with the deviation of the one or more expectations from the one or more results.

One or More Methods for Training an Expectation Generating Model According to Certain Embodiments

In certain embodiments, a method for training an expectation generating model includes a process of receiving a policy scenario associated with a policy lifecycle, a process of generating one or more expectations of the one or more policy details, a process of receiving one or more results of the one or more policy details, a process of determining the expectation generating model to be satisfactory, and/or a process of determining the expectation generating model to be unsatisfactory. Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others replaced. For example, some or all processes of the method are performed by a computing device or a processor directed by instructions stored in memory. As an example, some or all processes of the method are performed according to instructions stored in a non-transitory computer-readable medium.

In various embodiments, the process of receiving a policy scenario associated with a policy lifecycle includes receiving, by the expectation generating model, the policy scenario associated with the policy lifecycle. In certain examples, the policy scenario includes one or more events. In some examples, the one or more events includes policy purchase, driver modification, driver addition, driver removal, invoicing, vehicle modification, vehicle addition, vehicle removal, coverage modification, property modification, property addition, property removal, user info modification, risk addition, risk removal, risk update, profile update, payment method update, manual payment, policy reinstatement, policy repurchase, policy rewrite, policy re-rating, and/or policy termination.

In various embodiments, the process of generating one or more expectations of the one or more policy details includes generating, by the expectation generating model for each event of the one or more events, the one or more expectations of the one or more policy details. In some examples, the process of generating the one or more expectations includes sequentially generating the one or more expectations. In various examples, sequentially generating the one or more expectations includes generating a first set of expectations for a first event of the one or more events and generating a second set of expectations for a second event of the one or more events based at least in part upon the first set of expectations. In some examples, generating the first set of expectations is based at least in part upon the one or more initial values.

In various embodiments, the process of receiving one or more results of the one or more policy details includes receiving, by a validation model for each event of the one or more events, the one or more results of the one or more policy details.

In various embodiments, the process of determining the expectation generating model to be unsatisfactory includes determining the expectation generating model to be unsatisfactory if, for any event of the one or more events, the one or more expectations deviates from the one or more results greater than or equal to one or more predetermined thresholds.

In various embodiments, the process of determining the expectation generating model to be satisfactory includes determining the expectation generating model to be satisfactory if, for substantially all (e.g., more than 50%, 60%, 70%, 80%, 90%, 95%, or 99%) of the one or more events, the one or more expectations deviates from the one or more results lesser than the one or more predetermined threshold.

In some embodiments, the method further includes generating, by the validation model for each event of the one or more events, the one or more results of the one or more policy details, such as based at least in part upon the one or more initial values of the one or more policy details. In certain examples, generating the one or more results includes sequentially generating the one or more results. In some examples, sequentially generating the one or more results includes generating a first set of results for a first event of the one or more events, such as based at least in part upon the one or more initial values and generating a second set of results for a second event of the one or more events based at least in part upon the first set of results.

In some embodiments, the method further includes changing one or more parameters of the expectation generating model based at least in part upon one or more losses associated with the deviation of the one or more expectations from the one or more results. In certain examples, the expectation generating model is a machine learning model, such as an artificial neural network including adjustable weights and biases as parameters that are configured to be changed based at least in part upon one or more losses associated with the deviation of the one or more expectations from the one or more results.

In various embodiments, the method further includes a process of receiving one or more initial values of one or more policy details associated with a user policy includes receiving, by an expectation generating model, the one or more initial values of the one or more policy details associated with the user policy. In some examples, the one or more policy details includes billing information, operator information, payment details, payment history, policy update history, rating factor, vehicle information, and/or coverage information.

One or More Computer Devices According to Various Embodiments

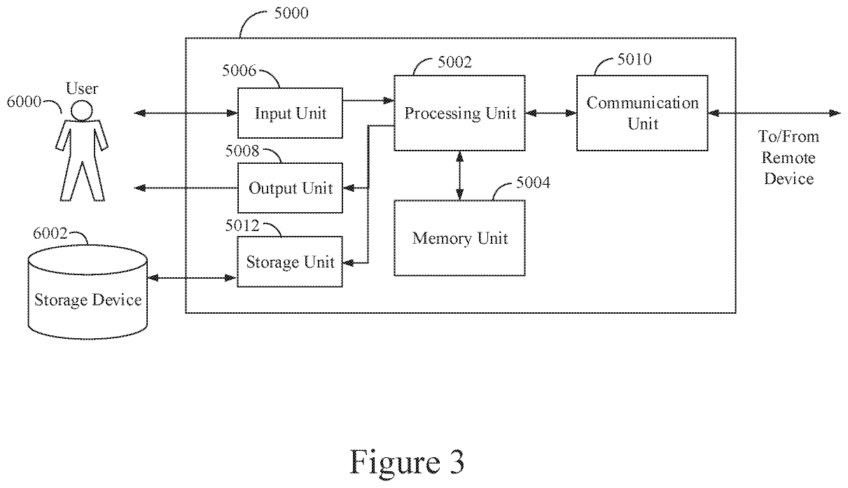

FIG. 3 is a simplified diagram showing a computer device 5000, according to various embodiments of the present disclosure. This diagram is merely an example, which should not unduly limit the scope of the claims. One of ordinary skill in the art would recognize many variations, alternatives, and modifications. In some examples, the computer device 5000 includes a processing unit 5002, a memory unit 5004, an input unit 5006, an output unit 5008, and a communication unit 5010. In various examples, the computer device 5000 is configured to be in communication with a user 5100 and/or a storage device 5200. In certain examples, the system computer device 5000 is configured according to system 10 of FIG. 1 and/or to implement method 100 of FIG. 2. Although the above has been shown using a selected group of components, there can be many alternatives, modifications, and variations. For example, some of the components may be expanded and/or combined. Some components may be removed. Other components may be inserted to those noted above. Depending upon the embodiment, the arrangement of components may be interchanged with others replaced.

In various embodiments, the processing unit 5002 is configured for executing instructions, such as instructions to implement method 100 of FIG. 2. In some embodiments, executable instructions may be stored in the memory unit 5004. In some examples, the processing unit 5002 includes one or more processing units (e.g., in a multi-core configuration). In certain examples, the processing unit 5002 includes and/or is communicatively coupled to one or more modules for implementing the systems and methods described in the present disclosure. In some examples, the processing unit 5002 is configured to execute instructions within one or more operating systems, such as UNIX, LINUX, Microsoft Windows®, etc. In certain examples, upon initiation of a computer-implemented method, one or more instructions is executed during initialization. In some examples, one or more operations is executed to perform one or more processes described herein. In certain examples, an operation may be general or specific to a particular programming language (e.g., C, C#, C++, Java, or other suitable programming languages, etc.). In various examples, the processing unit 5002 is configured to be operatively coupled to the storage device 5200, such as via an on-board storage unit 5012.

In various embodiments, the memory unit 5004 includes a device allowing information, such as executable instructions and/or other data to be stored and retrieved. In some examples, memory unit 5004 includes one or more computer readable media. In some embodiments, stored in memory unit 5004 include computer readable instructions for providing a user interface, such as to the user 5004, via the output unit 5008. In some examples, a user interface includes a web browser and/or a client application. In various examples, a web browser enables one or more users, such as the user 5004, to display and/or interact with media and/or other information embedded on a web page and/or a website. In certain examples, the memory unit 5004 include computer readable instructions for receiving and processing an input, such as from the user 5004, via the input unit 5006. In certain examples, the memory unit 5004 includes random access memory (RAM) such as dynamic RAM (DRAM) or static RAM (SRAM), read-only memory (ROM), erasable programmable read-only memory (EPROM), electrically erasable programmable read-only memory (EEPROM), and/or non-volatile RAM (NVRAN).

In various embodiments, the input unit 5006 is configured to receive input, such as from the user 5004. In some examples, the input unit 5006 includes a keyboard, a pointing device, a mouse, a stylus, a touch sensitive panel (e.g., a touch pad or a touch screen), a gyroscope, an accelerometer, a position detector (e.g., a Global Positioning System), and/or an audio input device. In certain examples, the input unit 5006, such as a touch screen of the input unit, is configured to function as both the input unit and the output unit.

In various embodiments, the output unit 5008 includes a media output unit configured to present information to the user 5004. In some embodiments, the output unit 5008 includes any component capable of conveying information to the user 5004. In certain embodiments, the output unit 5008 includes an output adapter, such as a video adapter and/or an audio adapter. In various examples, the output unit 5008, such as an output adapter of the output unit, is operatively coupled to the processing unit 5002 and/or operatively coupled to an presenting device configured to present the information to the user, such as via a visual display device (e.g., a liquid crystal display (LCD), a light emitting diode (LED) display, an organic light emitting diode (OLED) display, a cathode ray tube (CRT) display, an “electronic ink” display, a projected display, etc.) or an audio display device (e.g., a speaker arrangement or headphones).

In various embodiments, the communication unit 5010 is configured to be communicatively coupled to a remote device. In some examples, the communication unit 5010 includes a wired network adapter, a wireless network adapter, a wireless data transceiver for use with a mobile phone network (e.g., Global System for Mobile communications (GSM), 3G, 4G, or Bluetooth), and/or other mobile data networks (e.g., Worldwide Interoperability for Microwave Access (WIMAX)). In certain examples, other types of short-range or long-range networks may be used. In some examples, the communication unit 5010 is configured to provide email integration for communicating data between a server and one or more clients.

In various embodiments, the storage unit 5012 is configured to enable communication between the computer device 5000, such as via the processing unit 5002, and an external storage device 5200. In some examples, the storage unit 5012 is a storage interface. In certain examples, the storage interface is any component capable of providing the processing unit 5002 with access to the storage device 5200. In various examples, the storage unit 5012 includes an Advanced Technology Attachment (ATA) adapter, a Serial ATA (SATA) adapter, a Small Computer System Interface (SCSI) adapter, a RAID controller, a SAN adapter, a network adapter, and/or any other component capable of providing the processing unit 5002 with access to the storage device 5200.

In some examples, the storage device 5200 includes any computer-operated hardware suitable for storing and/or retrieving data. In certain examples, storage device 5200 is integrated in the computer device 5000. In some examples, the storage device 5200 includes a database, such as a local database or a cloud database. In certain examples, the storage device 5200 includes one or more hard disk drives. In various examples, the storage device is external and is configured to be accessed by a plurality of server systems. In certain examples, the storage device includes multiple storage units such as hard disks or solid-state disks in a redundant array of inexpensive disks (RAID) configuration. In some examples, the storage device 5200 includes a storage area network (SAN) and/or a network attached storage (NAS) system.

One or More Examples of Machine Learning According to Various Embodiments

According to some embodiments, a processor or a processing element may be trained using supervised machine learning and/or unsupervised machine learning, and the machine learning may employ an artificial neural network, which, for example, may be a convolutional neural network, a recurrent neural network, a deep learning neural network, a reinforcement learning module or program, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

According to certain embodiments, machine learning programs may be trained by inputting sample data sets or certain data into the programs, such as images, object statistics and information, historical estimates, and/or actual repair costs. The machine learning programs may utilize deep learning algorithms that may be primarily focused on pattern recognition and may be trained after processing multiple examples. The machine learning programs may include Bayesian Program Learning (BPL), voice recognition and synthesis, image or object recognition, optical character recognition, and/or natural language processing. The machine learning programs may also include natural language processing, semantic analysis, automatic reasoning, and/or other types of machine learning.

According to some embodiments, supervised machine learning techniques and/or unsupervised machine learning techniques may be used. In supervised machine learning, a processing element may be provided with example inputs and their associated outputs and may seek to discover a general rule that maps inputs to outputs, so that when subsequent novel inputs are provided the processing element may, based upon the discovered rule, accurately predict the correct output. In unsupervised machine learning, the processing element may need to find its own structure in unlabeled example inputs.

### Examples of Certain Implementations of the Present Disclosure

In certain embodiments, systems and/or methods of the present disclosure validate insurance management model or insurance management system without static expectation, such as expectation provided by a user and/or expectations manually inputted. In some examples, systems and/or methods of the present disclosure validate insurance management systems configured to provide 100% or near 100% (e.g., above 90%) automation coverage of insurance policies, each having a lifecycle scenario. In various examples, each lifecycle scenario includes multiple events corresponding to when the validation of policy details is performed. In certain examples, systems and/or methods of the present disclosure validate insurance management systems validate a plurality of lifecycle scenarios, such as more than 60%, 70%, 80%, or 90% of all scenarios of interest (e.g., to the user and/or owner of the insurance management systems), such as on the application programming interface (API) level.

In various samples, systems and/or methods of the present disclosure validate the plurality of scenarios fully, such as by validating each and every impacted API response after each event. For example, systems and/or methods of the present disclosure validate each API of multiple APIs in an insurance management system. In some examples, systems and/or methods of the present disclosure validate the multiple fields contained in each API response. For example, for an insurance management system having a scenario containing twenty API responses with each API response containing fifteen fields, systems and/or methods of the present disclosure validate three-hundred values. In various examples, a policy lifecycle includes one or more scenarios, each scenario includes one or more events, each event corresponds to one or more responses, and/or each response corresponds to one or more fields, that systems and/or methods of the present disclosure validate. In some examples, systems and/or methods of the present disclosure help reduce size of test file and time and cost needed for calculating and/or maintaining expectations used for validation.

In certain embodiments, systems and/or methods of the present disclosure provides a logic (e.g., an algorithm and/or a model), such as a built-in logic, configured to calculate one or more validation expectations for validating a program, such as an insurance management system. In some examples, the logic is configured to track a plurality of parameters associated with a policy, such as tracking a plurality of policy details, during validation over one or more lifecycle scenarios. In certain examples, the logic is configured to track a plurality of parameters associated with a policy, such as tracking a plurality of policy details, during validation over one or more events of each scenario. In various examples, systems and/or methods of the present disclosure eliminates the need for a user to provide, such as manually input, expectations for each field of an API response. In some examples, systems and/or methods of the present disclosure validate all API responses after each event, such as validate details that changed and details that are preserved and retained as-is. In some examples, systems and/or methods of the present disclosure ensure the system (e.g., insurance management system) behaves as intended.

In various examples, systems and/or methods of the present disclosure validate policy details at each and every event, which can include validating policy image (e.g., including a snapshot of the policy), payment history, projected next bill, account details, subledgers, and policy documents. For example, an example scenario includes a first event of purchasing an auto policy and validating policy details, a second event of moving a validation clock to a monthly billing date and validating generated bill and policy details, a third event of moving the validation clock to the due date and validating payment and policy details, a fourth event of applying a policy change to add an additional vehicle and validating all impacted policy details, a fifth event of moving the validation clock to the monthly billing date and validating generated bill and policy details, and a sixth step of moving the validation clock to the due date and validating payment and policy details.

In some examples, each event has a corresponding API, with each API containing multiple fields associated with various policy details such as policy status, sub-status, activation date, expiration date, number of risks, rating factors, payment methods, billing account, customer details, vehicle details, and/or driver details. In various examples, systems and/or methods of the present disclosure generate expectation for each of the field associated with an event, for use in validation of an insurance management program or insurance management system. In certain examples, multiple APIs are validated for each event.

In certain embodiments, systems and/or methods of the present disclosure automatically calculate expectations associated with various fields for various events associated with a scenario for validating an insurance management program. For example, for a scenario covering two vehicles, the validation process should confirm that the policy is active with two vehicles, and the payment history should include the policy and/or vehicle purchase records. The validation process may further confirm that there is a policy image corresponding to the policy, and that purchase documents have been generated. The validation process may further confirm that a billing document is generated on a billing date, a new payment record associated with billing is generated, and payment is scheduled on the payment date. In certain examples, systems and/or methods of the present disclosure generate expectations on-the-fly, such as by generating expectations sequentially where each subsequent expectation is generated based at least in part upon a previously generated expectation, except for the first expectation, which is generated based at least in part on policy details, such as initial values provided or set by default.

In certain embodiments, systems and/or methods of the present disclosure improves test management via the design and use of a logic, algorithm, and/or model that is trained and configured to generate expectations such that a user validating an insurance management program or system need not provide the expectations and instead can allocate more time and effort in designing the scenarios and the events associated with each scenario.

In certain embodiments, systems and/or methods of the present disclosure parallelly execute multiple policy scenarios, such as train an expectation generating model to generate expectations for multiple policy scenarios simultaneous, such as by receiving multiple policy scenarios as input and generating multiple sets of corresponding expectations as output.

In certain embodiments, systems and/or methods of the present disclosure provide an expectation generator algorithm for generating all expectations for all scenarios, such as based algorithms configured for corresponding system behavior(s). In certain examples, the test logic is simplified and derived from one or more business requirements, such as to validate the system against expectations generated by the expectation generating model.

In certain embodiments, if a system API response matches with expectations generated, such as an exact match or within a permissible threshold, tests are marked passed or satisfactory and the system is certified to be behaving as expected. Otherwise tests fail and reports may be shared with a development team.

### Examples of Certain Embodiments of the Present Disclosure

In various embodiments, a computer-implemented method for generating one or more expectations for a policy scenario includes: receiving, by an expectation generating model, a policy scenario associated with a policy lifecycle, the policy scenario including one or more events; sequentially generating, by the expectation generating model for each event of the one or more events, one or more expectations of one or more policy details associated with the policy lifecycle by at least: generating a first set of expectations for a first event of the one or more events; and generating a second set of expectations for a second event of the one or more events based at least in part upon the first set of expectations. In certain examples, the method is implemented according to at least FIG. 2.

In some embodiments, the method further includes: receiving, by the expectation generating model, one or more initial values of the one or more policy details. In certain examples, the generating the first set of expectations for the first event of the one or more events includes generating the first set of expectations based at least in part upon the one or more initial values.

In some embodiments, the method further includes validating a policy management model by at least: receiving, by the policy management model, the policy scenario associated with the policy lifecycle; sequentially generating, by the policy management model for each event of the one or more events, one or more value updates of the one or more policy details by at least: generating a first set of value updates for the first event of the one or more events; and generating a second set of value updates for the second event of the one or more events based at least in part upon the first set of value updates; determining the policy management model to be unsatisfactory if, for any event of the one or more events, the one or more value updates deviates from the one or more expectations greater than or equal to one or more predetermined thresholds; and/or determining the policy management model to be satisfactory if, for substantially all (e.g., more than 50%, 60%, 70%, 80%, 90%, 95%, or 99%) of the one or more events, the one or more value updates deviates from the one or more expectations lesser than the one or more predetermined thresholds.

In some embodiments, the method further includes receiving, by the policy management model, one or more initial values of one or more policy details. In certain examples, the generating the first set of value updates for the first event of the one or more events includes generating the first set of value updates based at least in part upon the one or more initial values.

In some embodiments, the one or more events includes policy purchase, driver modification, driver addition, driver removal, invoicing, vehicle modification, vehicle addition, vehicle removal, coverage modification, property modification, property addition, property removal, user info modification, risk addition, risk removal, risk update, profile update, payment method update, manual payment, policy reinstatement, policy repurchase, policy rewrite, policy re-rating, and/or policy termination.

In some embodiments, the one or more policy details includes billing information, operator information, payment details, payment history, policy update history, rating factor, vehicle information, and/or coverage information.

In some embodiments, the expectation generating model is a neural network.

In various embodiments, a system for generating one or more expectations for a policy scenario includes: a policy scenario receiving module configured to: receive, by an expectation generating model, a policy scenario associated with a policy lifecycle, the policy scenario including one or more events; and an expectation generating module configured to sequentially generate, by the expectation generating model for each event of the one or more events, one or more expectations of one or more policy details associated with the policy lifecycle by at least: generating a first set of expectations for a first event of the one or more events; and generating a second set of expectations for a second event of the one or more events based at least in part upon the first set of expectations. In certain examples, the system is implemented according to at least FIG. 1.

In some embodiments, the policy scenario receiving module is further configured to receive, by the expectation generating model, one or more initial values of the one or more policy details. In certain examples, the generating the first set of expectations for the first event of the one or more events includes generating the first set of expectations based at least in part upon the one or more initial values.

In some embodiments, the system further includes a validation module configured to validate a policy management model by at least: receiving, by the policy management model, the policy scenario associated with the policy lifecycle; sequentially generating, by the policy management model for each event of the one or more events, one or more value updates of the one or more policy details by at least: generating a first set of value updates for the first event of the one or more events; and generating a second set of value updates for the second event of the one or more events based at least in part upon the first set of value updates; determining the policy management model to be unsatisfactory if, for any event of the one or more events, the one or more value updates deviates from the one or more expectations greater than or equal to one or more predetermined thresholds; and determining the policy management model to be satisfactory if, for substantially all (e.g., more than 50%, 60%, 70%, 80%, 90%, 95%, or 99%) of the one or more events, the one or more value updates deviates from the one or more expectations lesser than the one or more predetermined thresholds.

In some embodiments, the validation module is configured to validate the policy management model by further receiving, by the policy management model, the one or more initial values of the one or more policy details. In certain examples, the generating the first set of value updates for the first event of the one or more events includes generating the first set of value updates based at least in part upon the one or more initial values.

In various embodiments, a non-transitory computer-readable medium with instructions stored thereon, that when executed by a processor, causes the processor to perform: receiving, by an expectation generating model, a policy scenario associated with a policy lifecycle, the policy scenario including one or more events; sequentially generating, by the expectation generating model for each event of the one or more events, one or more expectations of one or more policy details associated with the policy lifecycle by at least: generating a first set of expectations for a first event of the one or more events; and generating a second set of expectations for a second event of the one or more events based at least in part upon the first set of expectations. In certain examples, the non-transitory computer-readable medium is implemented according to at least FIG. 2.

In some embodiments, the non-transitory computer-readable medium, that when executed by a processor, further causes the processor to perform: receiving, by the expectation generating model, one or more initial values of the one or more policy details. In certain examples, the generating the first set of expectations for the first event of the one or more events includes generating the first set of expectations based at least in part upon the one or more initial values.

In some embodiments, the non-transitory computer-readable medium, that when executed by a processor, further causes the processor to perform: validating a policy management model by at least: receiving, by the policy management model, the policy scenario associated with the policy lifecycle; sequentially generating, by the policy management model for each event of the one or more events, one or more value updates of the one or more policy details by at least: generating a first set of value updates for the first event of the one or more events; and generating a second set of value updates for the second event of the one or more events based at least in part upon the first set of value updates; determining the policy management model to be unsatisfactory if, for any event of the one or more events, the one or more value updates deviates from the one or more expectations greater than or equal to one or more predetermined thresholds; and determining the policy management model to be satisfactory if, for substantially all (e.g., more than 50%, 60%, 70%, 80%, 90%, 95%, or 99%) of the one or more events, the one or more value updates deviates from the one or more expectations lesser than the one or more predetermined thresholds.

In some embodiments, the non-transitory computer-readable medium, that when executed by a processor, further causes the processor to perform: receiving, by the policy management model, one or more initial values of one or more policy details. In certain examples, the generating the first set of value updates for the first event of the one or more events includes generating the first set of value updates based at least in part upon the one or more initial values.

### Examples of Additional Embodiments of the Present Disclosure

In certain embodiments, a method for training an expectation generating model includes: receiving, by an expectation generating model, a policy scenario associated with a policy lifecycle, the policy scenario including one or more events; generating, by the expectation generating model for each event of the one or more events, one or more expectations of one or more policy details associated with the policy scenario; receiving, by a validation model for each event of the one or more events, one or more results of the one or more policy details; determining the expectation generating model to be unsatisfactory if, for any event of the one or more events, the one or more expectations deviates from the one or more results greater than or equal to one or more predetermined thresholds; and determining the expectation generating model to be satisfactory if, for substantially all (e.g., more than 50%, 60%, 70%, 80%, 90%, 95%, or 99%) of the one or more events, the one or more expectations deviates from the one or more results lesser than the one or more predetermined threshold.

In certain embodiments, the generating the one or more expectations includes sequentially generating the one or more expectations by at least: generating a first set of expectations for a first event of the one or more events; and generating a second set of expectations for a second event of the one or more events based at least in part upon the first set of expectations.

In certain embodiments, the computer-implemented method further includes generating, by the validation model for each event of the one or more events, the one or more results of the one or more policy details.

In certain embodiments, the generating the one or more results includes sequentially generating the one or more results by at least: generating a first set of results for a first event of the one or more events; and generating a second set of results for a second event of the one or more events based at least in part upon the first set of results.

In certain embodiments, the computer-implemented method further includes changing one or more parameters of the expectation generating model based at least in part upon one or more losses associated with the deviation of the one or more expectations from the one or more results.

In certain embodiments, a system for training an expectation generating model includes: a policy scenario receiving module configured to receive, by an expectation generating model, a policy scenario associated with a policy lifecycle, the policy scenario including one or more events; an expectation generating module configured to generate, by the expectation generating model for each event of the one or more events, one or more expectations of one or more policy details associated with the policy scenario; a result receiving module configured to receive, by a validation model for each event of the one or more events, one or more results of the one or more policy details; and an evaluation module configured to: determine the expectation generating model to be unsatisfactory if, for any event of the one or more events, the one or more expectations deviates from the one or more results greater than or equal to one or more predetermined thresholds; and determine the expectation generating model to be satisfactory if, for substantially all (e.g., more than 50%, 60%, 70%, 80%, 90%, 95%, or 99%) of the one or more events, the one or more expectations deviates from the one or more results lesser than the one or more predetermined threshold.

In certain embodiments, the expectation generating module is configured to sequentially generate the one or more expectations by at least: generating a first set of expectations for a first event of the one or more events; and generating a second set of expectations for a second event of the one or more events based at least in part upon the first set of expectations.

In certain embodiments, the system further includes a results generating module configured to generate, by the validation model for each event of the one or more events, the one or more results of the one or more policy details.

In certain embodiments, the expectation generating module is configured to sequentially generate the one or more results by at least: generating a first set of results for a first event of the one or more events; and generating a second set of results for a second event of the one or more events based at least in part upon the first set of results.

In certain embodiments, the system further includes a model changing module configured to change one or more parameters of the expectation generating model based at least in part upon one or more losses associated with the deviation of the one or more expectations from the one or more results.

In certain embodiments, a non-transitory computer-readable medium with instructions stored thereon, that when executed by a processor, causes the processor to perform: receiving, by an expectation generating model, a policy scenario associated with a policy lifecycle, the policy scenario including one or more events; generating, by the expectation generating model for each event of the one or more events, one or more expectations of one or more policy details associated with the policy scenario; receiving, by a validation model for each event of the one or more events, one or more results of the one or more policy details; determining the expectation generating model to be unsatisfactory if, for any event of the one or more events, the one or more expectations deviates from the one or more results greater than or equal to one or more predetermined thresholds; and determining the expectation generating model to be satisfactory if, for substantially all (e.g., more than 50%, 60%, 70%, 80%, 90%, 95%, or 99%) of the one or more events, the one or more expectations deviates from the one or more results lesser than the one or more predetermined threshold.

In certain embodiments, the non-transitory computer-readable medium, that when executed by a processor, further causes the processor to perform: generating, by the validation model for each event of the one or more events, the one or more results of the one or more policy details.

### Additional Considerations According to Certain Embodiments

In certain embodiments, some or all components of various embodiments of the present disclosure each are, individually and/or in combination with at least another component, implemented using one or more software components, one or more hardware components, and/or one or more combinations of software and hardware components. As an example, some or all components of various embodiments of the present disclosure each are, individually and/or in combination with at least another component, implemented in one or more circuits, such as one or more analog circuits and/or one or more digital circuits. For example, while the embodiments described above refer to particular features, the scope of the present disclosure also includes embodiments having different combinations of features and embodiments that do not include all of the described features. As an example, various embodiments and/or examples of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Certain implementations may also be used, however, such as firmware or even appropriately designed hardware configured to perform the methods and systems described herein.

The systems' and methods' data (e.g., associations, mappings, data input, data output, intermediate data results, final data results) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the present disclosure is not to be limited by the specific illustrated embodiments.

1. A computer-implemented method for generating one or more expectations for validating a policy management model, the method comprising:
receiving, by an expectation generating model, a plurality of policy life cycles, each policy life cycle of the plurality of policy life cycles including one or more events;
sequentially generating, by the expectation generating model for each event of the one or more events of each policy life cycle of the plurality of life cycles, one or more expectations of one or more policy details by at least:
generating a first set of expectations for a first event of the one or more events; and
generating a second set of expectations for a second event of the one or more events based at least in part upon the first set of expectations; and
validating a policy management model based at least upon the one or more expectations including:
receiving, by the policy management model, the plurality of policy life cycles;
sequentially generating, by the policy management model for each event of the one or more events of each policy life cycle of the plurality of life cycles, one or more value updates of the one or more policy details by at least:
generating a first set of value updates for the first event of the one or more events; and
generating a second set of value updates for the second event of the one or more events based at least in part upon the first set of value updates; and
determining the policy management model to be satisfactory or unsatisfactory by at least:
determining the policy management model to be unsatisfactory if, for any event of the one or more events, the one or more value updates deviates from the one or more expectations greater than or equal to one or more predetermined thresholds; and
determining the policy management model to be satisfactory if, for substantially all of the one or more events, the one or more value updates deviates from the one or more expectations lesser than the one or more predetermined thresholds.

2. The computer-implemented method of claim 1, further comprising:
receiving, by the expectation generating model, one or more initial values of the one or more policy details;
wherein the generating the first set of expectations for the first event of the one or more events includes generating the first set of expectations based at least in part upon the one or more initial values.

3. (canceled)

4. The computer-implemented method of claim 1, further comprising:
receiving, by the policy management model, one or more initial values of one or more policy details;
wherein the generating the first set of value updates for the first event of the one or more events includes generating the first set of value updates based at least in part upon the one or more initial values.

5. The computer-implemented method of claim 1, wherein the one or more events includes one of policy purchase, driver modification, driver addition, driver removal, invoicing, vehicle modification, vehicle addition, vehicle removal, coverage modification, property modification, property addition, property removal, user info modification, risk addition, risk removal, risk update, profile update, payment method update, manual payment, policy reinstatement, policy repurchase, policy rewrite, policy re-rating, and policy termination.

6. The computer-implemented method of claim 1, wherein the one or more policy details includes one of billing information, operator information, payment details, payment history, policy update history, rating factor, vehicle information, and coverage information.

7. The computer-implemented method of claim 1, wherein the expectation generating model is a neural network.

8. A system for generating one or more expectations for validating a policy management model, the system comprising:
a policy scenario receiving module configured to:
receive, by an expectation generating model, a plurality of policy life cycles, each policy life cycle of the plurality of policy life cycles including one or more events; and
an expectation generating module configured to sequentially generate, by the expectation generating model for each event of the one or more events of each policy life cycle of the plurality of life cycles, one or more expectations of one or more policy details by at least:
generating a first set of expectations for a first event of the one or more events; and
generating a second set of expectations for a second event of the one or more events based at least in part upon the first set of expectations; and
a validation module configured to validate a policy management model based at least upon the one or more expectations, and by at least:
receiving, by the policy management model, the plurality of policy life cycles;
sequentially generating, by the policy management model for each event of the one or more events of each policy life cycle of the plurality of life cycles, one or more value updates of the one or more policy details by at least:
generating a first set of value updates for the first event of the one or more events; and
generating a second set of value updates for the second event of the one or more events based at least in part upon the first set of value updates; and
determining the policy management model to be satisfactory or unsatisfactory by at least:
determining the policy management model to be unsatisfactory if, for any event of the one or more events, the one or more value updates deviates from the one or more expectations greater than or equal to one or more predetermined thresholds; and
determining the policy management model to be satisfactory if, for substantially all of the one or more events, the one or more value updates deviates from the one or more expectations lesser than the one or more predetermined thresholds.

9. The system of claim 8,
wherein the policy scenario receiving module is further configured to receive, by the expectation generating model, one or more initial values of the one or more policy details;
wherein the generating the first set of expectations for the first event of the one or more events includes generating the first set of expectations based at least in part upon the one or more initial values.

10. (canceled)

11. The system of claim 8,
wherein the validation module is configured to validate the policy management model by further receiving, by the policy management model, the one or more initial values of the one or more policy details;
wherein the generating the first set of value updates for the first event of the one or more events includes generating the first set of value updates based at least in part upon the one or more initial values.

12. The system of claim 8, wherein the one or more events includes one of policy purchase, driver modification, driver addition, driver removal, invoicing, vehicle modification, vehicle addition, vehicle removal, coverage modification, property modification, property addition, property removal, user info modification, risk addition, risk removal, risk update, profile update, payment method update, manual payment, policy reinstatement, policy repurchase, policy rewrite, policy re-rating, and policy termination.

13. The system of claim 8, wherein the one or more policy details includes one of billing information, operator information, payment details, payment history, policy update history, rating factor, vehicle information, and coverage information.

14. The system of claim 8, wherein the expectation generating model is a neural network.

15. A non-transitory computer-readable medium with instructions stored thereon, that when executed by a processor, causes the processor to perform:
receiving, by an expectation generating model, a plurality of policy life cycles, each policy life cycle of the plurality of policy life cycles including one or more events;
sequentially generating, by the expectation generating model for each event of the one or more events of each policy life cycle of the plurality of life cycles, one or more expectations of one or more policy details by at least:
generating a first set of expectations for a first event of the one or more events; and
generating a second set of expectations for a second event of the one or more events based at least in part upon the first set of expectations; and
validating a policy management model based at least upon the one or more expectations including:
receiving, by the policy management model, the plurality of policy life cycles;
sequentially generating, by the policy management model for each event of the one or more events of each policy life cycle of the plurality of life cycles, one or more value updates of the one or more policy details by at least:
generating a first set of value updates for the first event of the one or more events; and
generating a second set of value updates for the second event of the one or more events based at least in part upon the first set of value updates; and
determining the policy management model to be satisfactory or unsatisfactory by at least:
determining the policy management model to be unsatisfactory if, for any event of the one or more events, the one or more value updates deviates from the one or more expectations greater than or equal to one or more predetermined thresholds; and
determining the policy management model to be satisfactory if, for substantially all of the one or more events, the one or more value updates deviates from the one or more expectations lesser than the one or more predetermined thresholds.

16. The non-transitory computer-readable medium of claim 15, that when executed by a processor, further causes the processor to perform:
receiving, by the expectation generating model, one or more initial values of the one or more policy details;
wherein the generating the first set of expectations for the first event of the one or more events includes generating the first set of expectations based at least in part upon the one or more initial values.

17. (canceled)

18. The non-transitory computer-readable medium of claim 15, that when executed by a processor, further causes the processor to perform:
receiving, by the policy management model, one or more initial values of one or more policy details;
wherein the generating the first set of value updates for the first event of the one or more events includes generating the first set of value updates based at least in part upon the one or more initial values.

19. The non-transitory computer-readable medium of claim 15, wherein the one or more events includes one of policy purchase, driver modification, driver addition, driver removal, invoicing, vehicle modification, vehicle addition, vehicle removal, coverage modification, property modification, property addition, property removal, user info modification, risk addition, risk removal, risk update, profile update, payment method update, manual payment, policy reinstatement, policy repurchase, policy rewrite, policy re-rating, and policy termination.

20. The non-transitory computer-readable medium of claim 15, wherein the one or more policy details includes one of billing information, operator information, payment details, payment history, policy update history, rating factor, vehicle information, and coverage information.
